(19) United States
(12) Patent Application Publication
(10) Pub. No.: US 2007/0173196 A1
(43) Pub. Date: Jul. 26, 2007

(54) Built-In Low Power FM/VHF Transmitter for use of transmitting stored or streamed voice, music of video signals to entertainment systems wirelessly

(75) Inventor: Daniel Patrick Gallic, Warren, NJ (US)

Correspondence Address: Daniel Gallic, 44 Hillcrest Rd., Warren, NJ, 07059, US

(73) Assignee: Daniel Gallic, Warren, NJ (US)

(21) Appl. No.: 11/307,120

(22) Filed: Jan. 24, 2006

(51) Int. Cl. H04H 7/00; H04L 12/58

(52) U.S. Cl. 455/3.06; 455/412.1

(57) ABSTRACT

A built in FM Transmitter and/or VHF Transmitter, referred to as “transmitter”, for cellular, portable, or other wireless communication devices, referred to as “cell phone”, establishing stored voice, music or video over home or automobile entertainment centers, referred to as “entertainment centers”. The cellular or portable phone would have music or video stored on or transmitted to it via physical or wireless means. The cell phone has a built in low power transmitter for the expressed purpose of transmitting stored voice, music or video to nearby entertainment centers. There could be a special controller or device on the entertainment system for control, encryption or security of FM transmissions. An interface between the cell phone and the entertainment center would not be required. The transmitter and its controls can be housed in the cellular phone. There is no physical connection between the cellular phone and the entertainment center located in an automobile or elsewhere. The transmitter can be controlled through hardware or software housed or programmed into the cell phone.

### FIELD OF THE INVENTION

The present invention relates generally to the field of playing back and listening or watching stored or streaming music, voice and video information through a built in FM or VHF transmitter in the cell phone or wireless communications device. More particularly, the present invention is directed to devices that manage and store the video, music or voice information and already existing entertainment systems. The present invention facilitates the transfer of that data between wireless communication devices and multimedia devices, over FM or VHF transmissions.

### BACKGROUND OF THE INVENTION AND PRIOR ART

Cell phones and other wireless communication devices that store and playback music, voice and video information are very popular.

A problem associated with use of these devices is that, too often, they are only able to act as independent, standalone devices. Storage of audio, video and other data is normally limited to the original medium itself. High quality sound and video is unattainable through standard cell phones and other wireless communications devices, most utilizing a variety of ear phones and small LCD for watching video files.

There have been several devices proposed that address the transfer of data but there is no device that is actually built into the cell phone that plays back voice, music or voice files over present entertainment systems available in cars, homes and office using FM and VHF transmissions. For example, U.S. Pat. No. 4,713,801 to Hale discloses an audio device for automotive use in which radio signals are recorded onto magnetic tapes. The patent does not disclose the ability to cause the playback from multiple entertainment systems.

A further example is found in U.S. Pat. No. 6,212,555 to Brooks, Jr. et al. which discloses a digital recording device for recording, storing and playing back audio material. The device teaches recording and playback flexibility and teaches receiver unit use in an automobile.

However, the '555 patent does not address the storage and playback of video or other multimedia files, nor does it interface with other digital media.

Additionally, various consumer electronic devices allow, to a small degree, the transfer and interplay of various forms of data. However, none of these devices provide a universal interface or generic data transfer mechanism built into the cell phone.

For example, the Sony Clie Entertainment Handheld Organizer is a multifunction device that allows its user to take digital photos, play digital videos, record voice memos and play back digital audio files. However, the Sony device lacks the feature of universal connectivity. The Sony product cannot, for example, transfer cell phone audio content for playback on a car stereo.

The same is true for other devices on the market. MP3 players, digital voice recorders, camcorders and cell phones all have the ability to acquire and store data, but are unable to interface and share content with one another without a computer or some other dedicated intermediary device.

There is need, therefore, for a wireless cell phone that enables a user to universally store data from various media, digital audio and video, or other means and transfer it to other data sources without the need for multiple interconnectivity devices or a computer. Such uses and benefits include, but are not limited to, playback of cell phone voicemail by a car stereo, transfer of an image from a cell phone to a PDA, transfer of music from a cell phone to a car stereo, or conveyance of audio from a cell phone to a laptop computer. In short, the invention provides a universal interface between devices that operate on popular platforms of FM and VHF radio signals and enables a corresponding synergy attendant with the integration of a wide array of entertainment devices. The present invention is provided for cell phone housing. It is easy to envision the benefits of the invention. For example, a person driving home from work could play back his cell phone voicemail messages on his car stereo and play his favorite talk radio or music on his car radio. A user could download podcasts or other programming from a website on his cell phone and play it back at a later time on a stereo. The user could also download the latest sit-com and play it back on the TV mounted in the car by tuning into a preset VHF channel.

The instant invention provides a break through in the playback and digital and analog audio and video data for playback available in cell phones and other wireless communication devices without the presence physical connection between the devices.

### OBJECTS AND ADVANTAGES OF THE INVENTION

It is an object of this invention to provide a transmission device for stored or streaming audio, visual and other multimedia data available on a cell phone or other wireless communication devices without having to connect the mediums physically.

It is also an object of this invention to facilitate the playback of music, video and voice stored or streamed through a cell phone to automobile entertainment systems.

It is further an object of this invention to allow for software and hardware available in the body of the cell phone to control the signal processing of the FM or VHF signal, including frequency tuning to fixed frequencies.

It is an object of this invention to allow the owner of a cell phone with the ability to store or stream music, video or voice, to simply place the cell phone anywhere in the car and have it transmit the stored or streamed music, video or voice to the car stereo or car video player.

### BRIEF DESCRIPTION OF THE INVENTION

According to the invention, a low power FM or VHF transmitter built into a cell phone and controlled by hardware and software within the body of the cell phone.

The device provides at least these capabilities:

The transmission of signals that would normally be heard on the earphone or earpiece of a cell phone to a FM or VHF transmitter.

The ability to control the low powered built in FM and VHF transmitter through the use of software and hardware embodied in the cell phone.

### BRIEF DESCRIPTION OF DRAWINGS

FIG. 1—Typical Embodiment of the Invention: Drawing shows cell phone that has the ability to store or stream voice, music or video with invention built in and the approximate distance to an automobile's entertainment center.

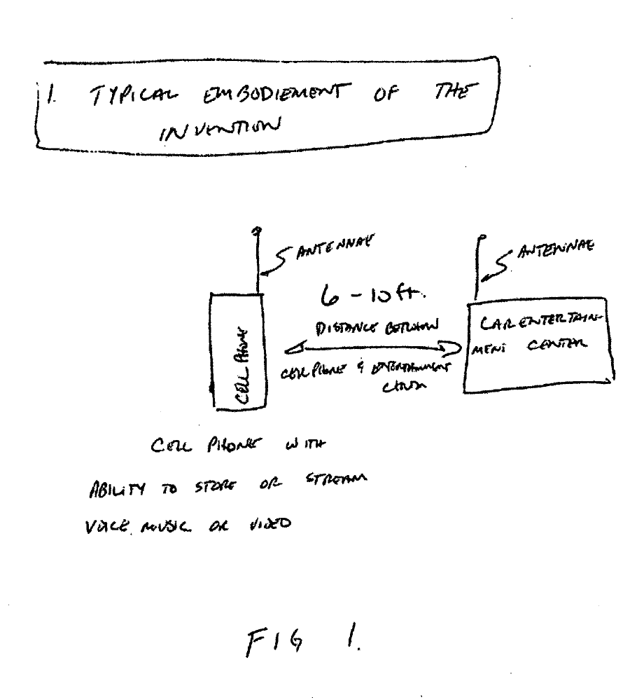

FIG. 2—Typical information flow within the typical embodiment of a cell phone with the invention built in. Data, stored in the cell phone or streamed through the cell phone would be converted to analog signal. This signal would be sent to the invention. The invention would then transform the signal into an FM or VHF signal using the cell phones antennae to help transmit the FM or VHF signal. In the invention itself, there would be controlling software or hardware to process the audio or video feed. This software and hardware could also be placed outside the invention within the cell phone software or the actual cell phone itself.

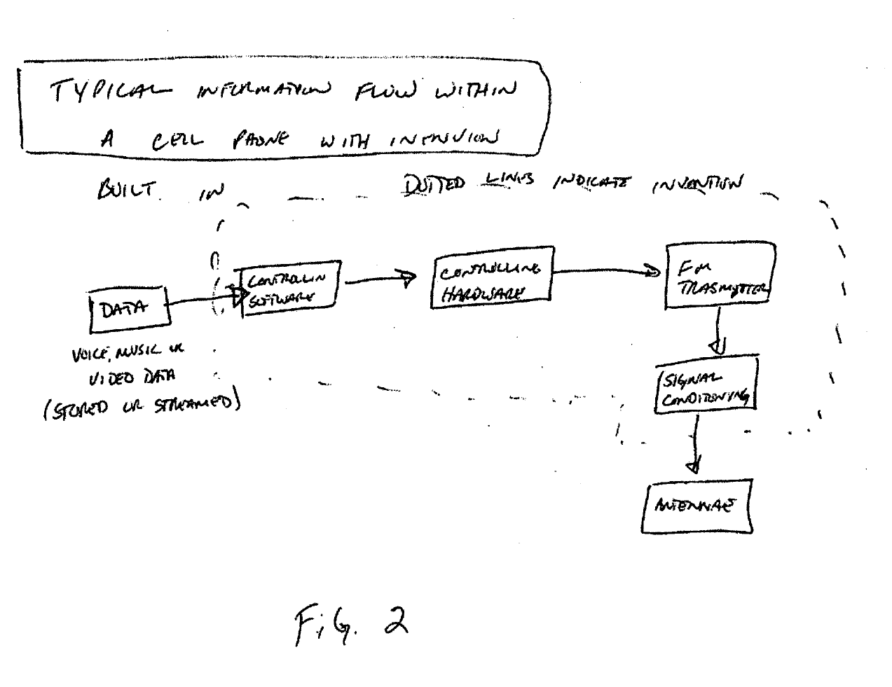

FIG. 3—Typical physical placement of the invention within a cell phone. Signal that normal would go to the headphone jack are routed through the invention. The invention then produced the FM signal and uses the cell phone antennae for transmission. Digital or analog wires are used to transmit information from the cell phone software and hardware to the invention to control signal processing and FM transmission.

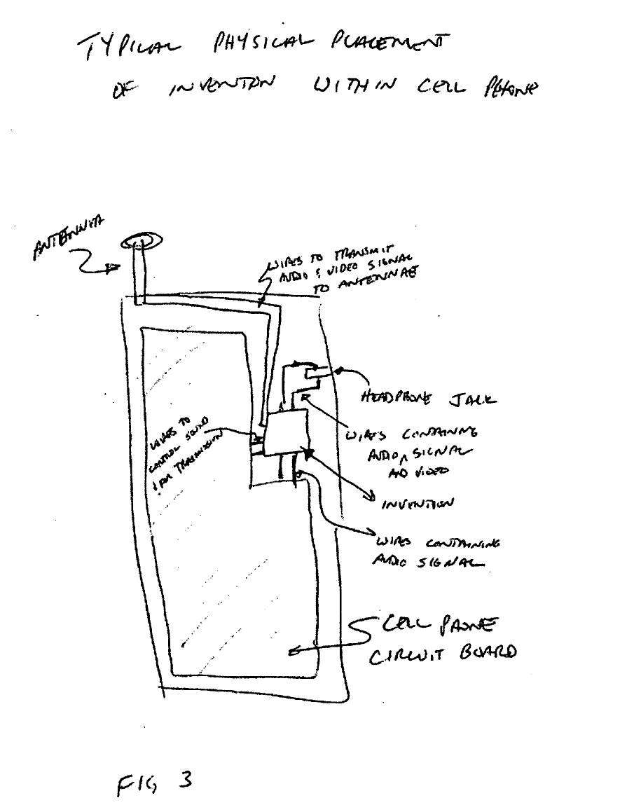

What is claimed is:

1. A method of using a wireless communication device with stored music, voice or video information, the method comprising: a cell phone, portable phone or wireless communications device with stored voice, music or video to be transmitted with a built-in low power FM and/or VHF transmitter to a car radio, entertainment system, television with no physical connection between the transmitter of the signal and the receiver of the signal.

2. Method as cited in claim 1 further comprising of software or hardware to process and manipulate the stored voice, music or video signals through the built in low powered FM or VHF transmitter.

3. A method as cited in claim 1 further comprising ability to route streaming voice, music or video over the same built in low powered FM or VHF transmitter.

4. A method as cited in claim 1 further comprising of the tuning of the built in low powered FM or VHF transmitter to a fixed wavelength.

5. A method as cited in claim 1 further comprising of the tuning of the built in low powered FM or VHF transmitter to an adjustable wavelength.
